(19) United States
(12) Patent Application Publication
(10) Pub. No.: US 2012/0089810 A1
(43) Pub. Date: Apr. 12, 2012

(54) Apparatus and Method for Formatting and Preselecting Trace Data

(75) Inventors: Albrecht Mayer, Deisenhofen (DE); Harry Siebert, Puchheim (DE)

(73) Assignee: Infineon Technologies AG, Neubiberg (DE)

(21) Appl. No.: 13/253,544

(22) Filed: Oct. 5, 2011

(30) Foreign Application Priority Data
Oct. 7, 2010 (DE) 102010047718.4

(51) Int. Cl. G06F 12/10

(52) U.S. Cl. 711/207; 711/E12.061

(57) ABSTRACT

The invention relates to a method and apparatus for formatting and preselecting trace data, and includes a trace message generator, an address checker, and a memory connected to the trace message generator and address checker. The trace message generator is configured to receive an address and associated data and generate a trace message with the associated data for the received address. The address checker is configured to receive the address, check the received address with the aid of the memory, and generate an output signal that indicates whether or not the trace message generated for the address is intended to be stored. The memory is configured to receive the trace message generated by the trace message generator, receive the output signal generated by the address checker, and store the received trace message if the output signal indicates that the trace message is intended to be stored.

### REFERENCE TO RELATED APPLICATION

This application claims priority to German application number DE 102010047718.4 filed on Oct. 7, 2010.

### FIELD

The invention relates to a method and apparatuses for formatting and preselecting trace data.

The invention is used, in one embodiment, in automotive technology, for example for the purpose of monitoring a control apparatus in a vehicle.

### BACKGROUND

The control apparatus to be monitored may be, for example, an engine controller for a motor vehicle, an embedded system or the like, which can be used to control actuators, for example electric motors, controllers or the like. Sensors, for example optical sensors, measuring transducers or the like, can also be connected to the control apparatus. The processor of the control apparatus executes a control program, for example in order to monitor the actuator, to control injection quantities of an internal combustion engine or the like. The processor of the control apparatus is generally connected to a memory in order to store, for example, control parameters and other used, measured and/or calculated variables there and to read the latter from said memory again. The variables or sets of variables may contain, for example, measured values, temporary controller values, output values at actuators or the like. The at least one variable may also comprise at least one program variable, in particular so-called global program variables which are jointly used by a plurality of program parts or functions.

A plurality of methods are known for the purpose of recording the memory access operations of the processor. In the case of microprocessors without internal peripherals and memories, it is conventional practice to record the external address/data bus and some control signals. The prerequisite for this so-called bus trace method is physical access to the memory interface of the control apparatus. Adapters which tap off the signals either directly from the CPU or directly from the memory module are typically used here. The signals may also be tapped off on the path between the CPU and the memory using PressOn adapters for conductor track pads or connectors. If a physical connection is possible in this manner, all memory access operations can be recorded and the program flow and all data access operations can be determined therefrom.

There are restrictions if the CPU is provided with a cache or internal RAM. In this case, the situation may occur in which no bus cycle appears on the external bus interface for a long period of time because all data required are already present in the internal memory and are executed there. In this case, a trace tool cannot record anything and the program behavior remains hidden.

However, ever higher integration densities and pricing pressure have resulted in the CPU core, cache, peripherals, flash and RAM memories being integrated in only one housing in many processors (system-on-chip). These processors often no longer even have an external memory interface. The bus trace method cannot be used in this case. Therefore, many recent CPU architectures provide a special trace interface on the chip in addition to the debug interface. This trace interface can be used to make the program flow visible to the outside in compressed form. This procedure is often referred to as the flow trace method.

A trace bus which has a width of 4, 8 or 16 bits and can be used to transmit program flow data and/or data access operations at a bus frequency of up to 400 MHz in compressed form is usually used as the trace interface. In this case, the information on the address bus/data bus is transmitted in the manner in which it directly occurs in the CPU core. This means that operations to access chip-internal flash or RAM memory—in particular the cache—can also be recorded.

However, one disadvantage of this trace method is the wide bandwidth needed to transmit the trace data. The problem is intensified in multi-core systems since the required bandwidth increases linearly with the number of processors. This is a significant cost factor for the chip in terms of the area required on the semiconductor chip and the housing pins required. This method also requires the tool hardware to be closely coupled to the processor, this local proximity being not only another cost factor but also a technical challenge. This is because the tool hardware has semiconductor modules (field programmable gate arrays (FPGAs), memory modules, etc.) which are not suitable for use in the automotive sector, in particular are not designed for ambient temperatures of −40° C. to 125° C.

### SUMMARY

The present invention is directed to an apparatus for processing trace data, which apparatus is suitable for use in the automotive sector, is more cost-effective and, in particular, requires a narrower bandwidth.

One embodiment of the invention provides an apparatus for formatting and preselecting trace data, the apparatus comprising means for generating trace messages, means for checking addresses that have at least one look-up table, and memory means connected to the means for generating trace messages and to the means for checking addresses. The means for generating trace messages is configured to receive an address and associated data and generate a trace message with the associated data for the received address. The means for checking addresses is configured to receive the address, check the received address with the aid of the look-up table and generate an output signal that indicates whether or not the trace message generated for the address is intended to be stored. The memory means is configured to receive the trace message generated by the means for generating trace messages, receive the output signal generated by the means for checking addresses, and if the output signal indicates that the trace message is intended to be stored, store the received trace message.

The means for checking addresses also comprises, in one embodiment, a multiplicity of means for comparing addresses, that are configured to investigate whether the received address is in an address range respectively associated with the means, generate a bit signal which is in a first state when the received address is in the associated address range and is in a second state when the received address is not in the associated address range, and generate a relative address based on the received address and the associated address range. Further, the means for checking addresses comprises a multiplexer configured to respectively receive the relative address and the bit signal from the comparison means, forward the relative address from the means for comparing addresses, the bit signal of which is in the first state, when only one bit signal in the first state was received, and forward the relative address from the means for comparing addresses, the bit signal of which is in the first state and which has a highest priority, when a plurality of bit signals in the first state were received. The means for checking addresses is also configured to check the received address with the aid of the look-up table and the relative address.

Another embodiment of the present invention provides an apparatus for formatting and preselecting trace data, the apparatus comprising a trace data formatter, an address tester having at least one look-up table, and a memory connected to the trace data formatter and the address tester. The trace data formatter is configured to receive an address and associated data and generate a trace message with the associated data for the received address. The address tester is configured to receive the address, and check the received address with the aid of the at least one look-up table and generate an output signal that indicates whether or not the trace message generated for the address is intended to be stored. The memory is configured to receive the trace message generated by the trace data formatter, receive the output signal generated by the address tester, and if the output signal indicates that the trace message is intended to be stored, to store the received trace message.

In one embodiment of the invention, the address tester comprises a multiplicity of address comparators, with a predefined address range and further parameters being associated with each address comparator from the multiplicity of address comparators. Each address comparator is configured to investigate whether the received address is in the address range associated with the comparator, generate a bit signal which is in a first state when the received address is in the address range associated with the comparator and is in a second state when the received address is not in the address range associated with the comparator, and generate a relative address based on the received address and the parameters associated with the comparator. The address tester further comprises a multiplexer configured to respectively receive the relative address and the bit signal from the address comparators and forward the relative address from the address comparator, the bit signal of which is in the first state. The address tester is also configured to check the received address using an entry in the look-up table, which entry is associated with the relative address.

In another exemplary embodiment of the invention, the address tester comprises a multiplicity of address comparators, with a predefined address range and further parameters being associated with each address comparator from the multiplicity of address comparators. Each address comparator is configured to investigate whether the received address is in the address range associated with the comparator, generate a bit signal which is in a first state when the received address is in the address range associated with the comparator and is in a second state when the received address is not in the address range associated with the comparator, and generate a relative address based on the received address and the parameters associated with the comparator. The address tester also comprises a multiplexer configured to respectively receive the relative address and the bit signal from the address comparators, forward the relative address from the address comparator, the bit signal of which is in the first state, when only one bit signal in the first state was received, and forward the relative address from the address comparator, the bit signal of which is in the first state and which has the highest priority, when a plurality of bit signals in the first state were received. The address tester is further configured to check the received address using an entry in the look-up table, which entry is associated with the relative address.

Another embodiment of the present invention provides a method for formatting and preselecting trace data, the method comprising receiving an address and associated data, and generating a trace message with the associated data for the received address. The method further comprises checking, with the aid of a look-up table, whether the trace message generated for the address is intended to be stored, generating an output signal which indicates whether or not the trace message generated for the address is intended to be stored, transmitting the generated trace message and the generated output signal to a memory apparatus, and storing the generated trace message if the output signal indicates that the trace message is intended to be stored.

### BRIEF DESCRIPTION OF THE DRAWINGS

The present invention is explained in more detail using a plurality of preferred exemplary embodiments in the following figures.

FIG. 1 shows a diagrammatic, exemplary block diagram of an apparatus for formatting and preselecting trace data according to one exemplary embodiment of the present invention.

FIG. 2 shows a diagrammatic, exemplary block diagram of a first exemplary embodiment of a means for checking addresses from FIG. 1.

FIG. 3 shows a diagrammatic, exemplary block diagram of a second exemplary embodiment of a means for checking addresses from FIG. 1.

### DETAILED DESCRIPTION

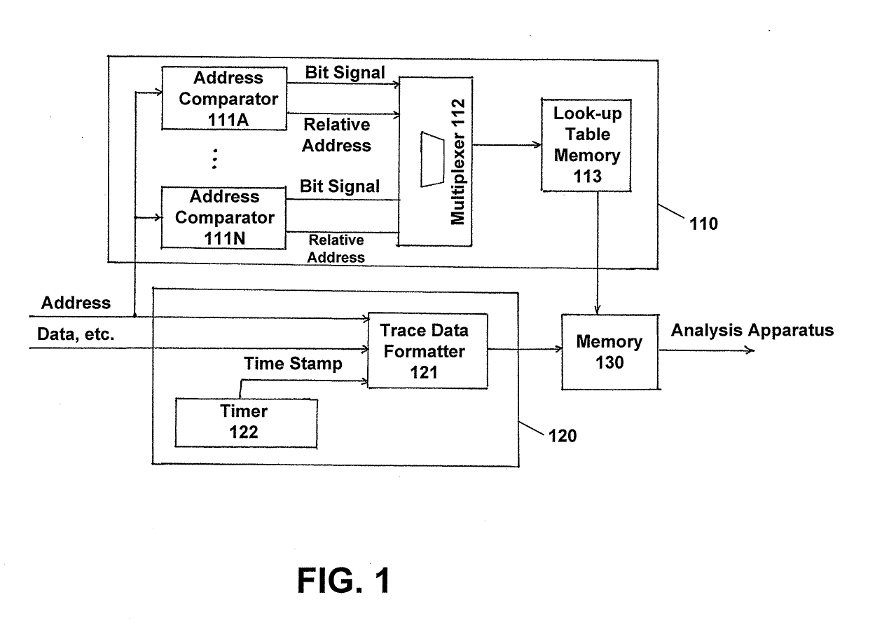

FIG. 1 shows a diagrammatic, exemplary block diagram of an apparatus for formatting and preselecting trace data according to one exemplary embodiment of the present invention.

The apparatus illustrated in FIG. 1 has a trace message generator 120, an address checker 110 and a memory 130 that is connected to the trace message generator 120 and to the address checker 110.

In this exemplary embodiment, the trace data generator 120 comprises a trace data formatter 121 and a clock generator/timer 122. In this example, the memory 130 is a FIFO (First-In-First-Out) memory.

In this exemplary embodiment, the address checker 110 has a multiplicity or plurality of address comparators 111a-111n, a multiplexer 112 and a look-up table memory 113 which, in one embodiment, has a multiplicity or plurality of look-up tables.

The address comparators 111a-111n each receive the address to be checked as the input. Their outputs are connected to the inputs of the multiplexer 112. The output of the multiplexer 112 is connected to the look-up table memory 113 which is also connected to the memory 130.

A particular address range is respectively associated with the address comparators 111a-111n. If an address is received by the address checker 110, each address comparator checks whether the received address is in the address range associated with the comparator. The address comparator advantageously outputs the result in the form of a bit, for example a “1” if the received address is inside the address range associated with the comparator, otherwise a “0”.

The address comparator also calculates a relative address for the look-up table memory 113 from the received address. If the received address is in the address range of the address comparator, the relative address indicates the associated position in the look-up table memory 113. Individual relative address ranges inside the look-up table memory 113 are therefore associated with the respective address ranges of the individual address comparators. This makes it possible to investigate any desired subranges from the total quantity of all possible addresses, even subranges which are not contiguous.

Each address comparator transfers the information “address is in address range” and “address is not in address range”, for example in the form of a bit (called a comparison bit below), together with the calculated relative address, to the multiplexer 112. The multiplexer selects a relative address from the multiplicity of received relative addresses with the aid of the comparison bit that is transmitted in a parallel manner and transmits this relative address to the look-up table memory 113.

In this case, the multiplexer 112 selects the relative address as follows:

If the multiplexer 112 receives a comparison bit with the information “address is in address range”, for example a bit with the value “1”, exactly once, the multiplexer 112 selects the relative address which it has received from one of the address comparators together with this comparison bit.

If the multiplexer 112 receives a plurality of comparison bits containing the information “address is in address range”, it selects, from the associated relative addresses, the relative address which it has received from the address comparator with the highest priority. For this purpose, a defined priority is associated with each address comparator and thus with each of the subranges to be investigated from the total quantity of all possible addresses.

If the multiplexer 112 does not receive a comparison bit with the information “address is in address range”, the multiplexer outputs a predefined “zero value” containing the information “address is not in any of the address ranges to be investigated”.

The look-up table memory 113 contains, for each address from the address ranges to be investigated, an entry containing information relating to whether the trace data received for the corresponding address are intended to be stored in the memory 130. A bit is expediently associated with each address to be investigated in the look-up table memory 113. For a relative address which has been input, the look-up table therefore outputs a bit containing the following information content:

If the bit contains the value “1”, for example, the trace data which are to be associated with the relative address which has been input are intended to be stored in the memory 130.

If the bit contains the value “0”, for example, the trace data which are to be associated with the relative address which has been input are not intended to be stored in the memory 130.

If the look-up table memory 113 has received a zero value from the multiplexer 112, that is to say the address is not in any of the address ranges to be investigated, it outputs a bit with the value “0” in this example.

It should be taken into account that the above association between the bit value and the information content is used only as an example and other associations are likewise conceivable if they are clear.

The look-up table memory 113 expediently contains a multiplicity of individual look-up tables, a look-up table advantageously being respectively associated with an address comparator and thus an address subrange. However, it is also conceivable, for example, for two address comparators to access a common look-up table, for example in the case of memory areas which can be accessed under different addresses.

The address comparator checks whether the received address is in its address range. If this is the case, the corresponding look-up table, that is to say the table associated with the address comparator, is used to check whether the formatted trace data generated for this address are intended to be stored in the memory 130. In this case, the conversion of the received address into a relative address, which is carried out by the address comparator, ensures that the correct look-up table, that is to say the table associated with the address comparator, is accessed.

If the received address is not in the address range of the address comparator (address comparator transmits corresponding information to the multiplexer 112), the look-up table associated with the address comparator is not accessed and is inactive in this process.

The trace data formatter 121 also receives the address, which, as described above, is received and processed by the address checker 110, and data associated with the address, for example a task ID, etc. The clock generator/timer 122 optionally generates a time stamp and transmits the latter to the trace data formatter 121. The trace data formatter 121 uses the address, the associated data and the time stamp to generate a trace message and forwards the latter to the memory 130.

The memory 130 receives, from the trace data formatter 121, the trace message generated for the address and the bit output by the look-up table memory 113 for the same address. Only if the bit output by the look-up table memory 113 indicates that the corresponding trace message is intended to be stored, that is to say has the value “1” for example, is the trace message written to the memory 130. A trace message whose associated address the bit output by the look-up table memory 113 indicates that the corresponding trace message is not intended to be stored, that is to say has the value “0” for example, is not stored.

The trace messages stored in the memory 130 can be read by a suitable analysis tool or a suitable analysis apparatus. In one exemplary embodiment of the invention, this may be effected, for example, by the analysis tool using an already existing debug interface, the trace data being read word-by-word via the debug interface.

In one exemplary embodiment of the invention, a high-speed interface is provided for reading the data. In this case, the trace data are transmitted to the suitable analysis tool or the suitable analysis apparatus via the high-speed interface.

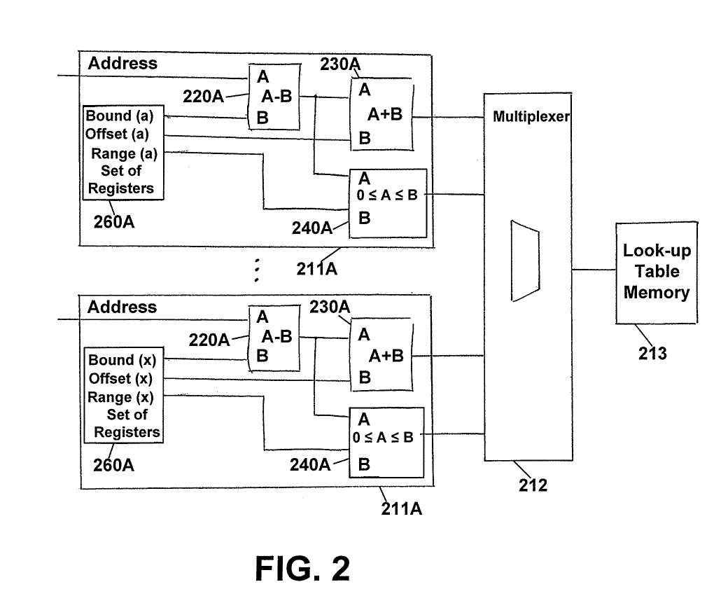

FIG. 2 shows a diagrammatic, exemplary block diagram of a first exemplary embodiment of the address checker from FIG. 1. In particular, the address comparators are illustrated in more detail in FIG. 2.

In one embodiment the address comparators 211a-211n all have the same structure but receive different parameter values as the input, which parameter values define, inter alia, the different address ranges to be investigated in each case. Therefore, the structure and method of operation of the “first” address comparator 211a (of the first address comparator) are explained in more detail below by way of example, in which case it should be emphasized that the following statements apply to all the address comparators 211a-211n.

The first address comparator 211a has a subtractor 220a, an adder 230a, a comparator 240a and a set of registers 260a. The address comparator 211a receives the address to be checked via an input, and parameters for checking the received address and determining the relative address are stored in the set of registers 260a; in particular, the parameters stored in the set of registers 260a define the address range of the first address comparator 211a, which address range is to be investigated.

The address range of the first address comparator 211a is defined by the parameters BOUND(a) and RANGE(a). In this case, the parameter BOUND(a) denotes the lower limit of the address range and the parameter RANGE(a) denotes the size of the address range, the interval length as it were. The upper limit of the address range can therefore be expressed as BOUND(a)+RANGE(a).

The subtractor 220a subtracts the parameter BOUND(a) from the received address value and transfers the difference value to the adder 230a and to the comparator 240a. The adder 230a adds the parameter OFFSET(a) to the difference value in order to obtain the relative address associated with the received address for the look-up table memory 113 as the sum. A particular relative address range in the look-up table memory 213 is therefore associated with the address range of the address comparator using the parameter OFFSET(a).

The comparator 240a checks whether the received address is in the address range of the first address comparator 111a. For this purpose, the comparator 240a checks whether the value received from the subtractor 220a is greater than or equal to 0 and, at the same time, is less than or equal to the parameter value RANGE(a). Expressed as a double inequality, this condition is as follows:

0≦(address−BOUND(a))≦RANGE(a)

or

BOUND(a)≦address≦(RANGE(a)+BOUND(a))

The “actual” condition for checking the addresses can be directly gathered from the rearranged double inequality: the comparator checks whether the received address is in the address interval defined by the first limit (BOUND(a)) and the second limit (RANGE(a)+BOUND(a)).

The address ranges of the individual address comparators can therefore be defined by suitably selecting the parameters BOUND(x), RANGE(x) and the address ranges to be investigated can therefore be defined in any desired manner. Address ranges that are not contiguous or even overlapping address ranges can therefore also be investigated.

The original “absolute” addresses can be mapped to relative addresses inside the look-up table memory 213 by suitably selecting the parameter OFFSET(x). For example, in one embodiment the look-up table memory 213 may have a plurality of individual look-up tables, a look-up table in the look-up table memory 213 advantageously being provided for each address comparator and the address range of an address comparator to be investigated in each case being mapped to a look-up table.

Since the parameters, BOUND(x), RANGE(x) and OFFSET(x) can each be separately defined for the individual address comparators, that is to say can be assigned different values, various possibilities for making the address checking effective are presented:

Within an address range to be investigated, individual subranges can be masked by virtue of “gaps' remaining free between the individual address ranges of the address comparators, that is to say the address ranges of the address comparators are defined in such a manner that an address range which is not contiguous is defined overall.

A common (sub)section of the look-up table memory 213 is associated with a plurality of different address ranges to be checked by virtue of: (1) identical values for the parameter OFFSET(x) being allocated to the corresponding address comparators; or (2) the parameters OFFSET(x) of the corresponding address comparators being selected in a suitable manner, with the result that the sections of the look-up table memory 213 that are associated with two different address comparators overlap.

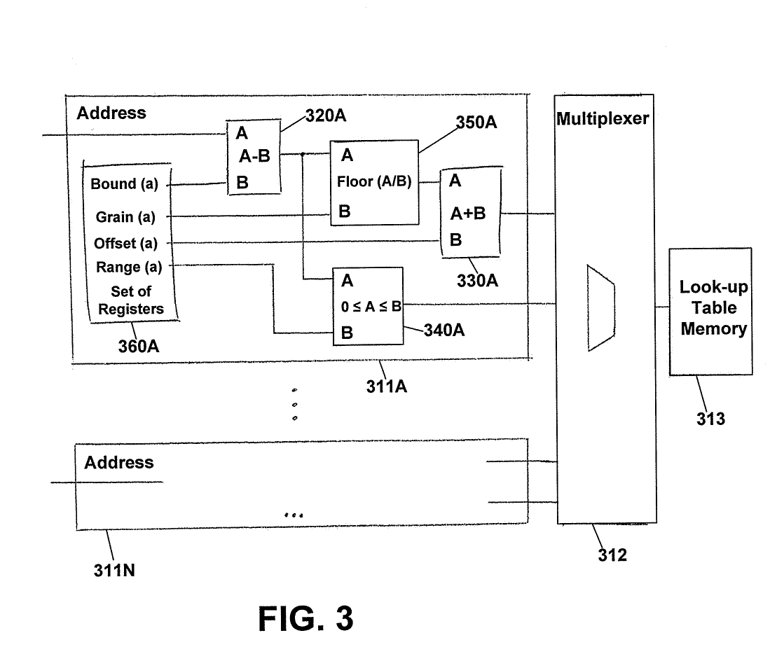

FIG. 3 shows a diagrammatic, exemplary block diagram of a second exemplary embodiment of the address checker from FIG. 1. In particular, the address comparators are illustrated in more detail in FIG. 3.

The address comparators 311a-311n all have the same structure but receive different parameter values as the input, which parameter values define, inter alia, the different address ranges to be investigated in each case. Therefore, the structure and method of operation of the “first” address comparator 311a (of the first address comparator) are explained in more detail below by way of example, in which case it should be emphasized that the following statements apply to all the address comparators 311a-311n.

The first address comparator 311a has a subtractor 320a, a divider 350a, an adder 330a, a comparator 340a and a set of registers 360a. The address comparator 311a receives the address to be checked via an input, and the parameters BOUND(a), RANGE(a), GRAIN(a) and OFFSET(a) for checking the received address and determining the relative address are stored in the set of registers 360a.

Like the exemplary embodiment described above according to FIG. 2, the address range of the first address comparator 311a is defined by the parameters BOUND(a) and RANGE(a). The check as to whether the received address is in the address range of the first address comparator 311a is also carried out in a similar manner to the method explained in the description of the exemplary embodiment according to FIG. 2.

The difference between the exemplary embodiments shown in FIGS. 2 and 3 lies in the calculation of the relative addresses for the look-up table memory 313.

The subtractor 220a subtracts the parameter BOUND(a) from the received address value and transfers the difference value to the divider 350a. The divider divides the difference value received from the subtractor by the parameter GRAIN(a) and rounds off the obtained result. The adder 230a adds the parameter OFFSET(a) to the rounded-off result received from the divider 350a in order to obtain the relative address (RelAddr) associated with the received (absolute) address (absAddr) for the look-up table memory 313 as the sum:

$$\begin{matrix}RelAddr = floor [ absAddr - BOUND ( a ) / GRAIN ( a ) ] + OFFSET ( a ) \\ = {}^{⌊} ( absAddr - BOUND ( a ) ) / {GRAIN ( a )}^{⌋} + OFFSET ( a ) .\end{matrix}$$

The rounding-off function, represented by the equivalent symbols floor(x) and └x┘, is used in this case.

The parameter GRAIN(x) which is newly included in this exemplary embodiment indicates the granularity or resolution of the respective address comparator.

For GRAIN(x)=1, precisely one “absolute” address is associated with a relative address in the corresponding part of the look-up table memory 313 (apart from in the case of overlapping address ranges). The exemplary embodiment according to FIG. 2 can therefore be considered to be a special case of the exemplary embodiment according to FIG. 3, in which the parameter GRAIN(x)=1 is set for each of the address comparators 311a-311n. In this case, a bit is needed, for example, to indicate whether a particular address (associated with this bit) is intended to be monitored and whether the trace message generated for this address is intended to be stored in the memory 130.

For values of GRAIN(x)>1, more than one “absolute” address is mapped to a relative address in the corresponding part of the look-up table memory 313. Therefore, 2, 4, 8 or more addresses/bytes or 16, 32, 64 or more bits, for example, can be mapped to one relative address or 1 bit in the look-up table memory 313, for example.

Larger values of the parameter GRAIN(x) are therefore advantageous, on the one hand, since less space in the look-up table memory 313 is required for a predefined address range to be monitored. On the other hand, it should be taken into account that the relevant addresses are combined to form smaller subgroups, all addresses or no address of which is/are to be monitored since only one bit in the look-up table memory 313 is respectively associated with the entire group of addresses. For larger values of GRAIN(x), the subgroups in which the addresses are combined also become larger and more data/addresses are therefore also “unintentionally” monitored if they are in a group with data/addresses which are intended to be monitored.

As an example, the value 4 shall now be selected for the first address comparator 311a. In this case, 4 addresses (32 bits) from the address range associated with the first address comparator are respectively combined and are mapped to one bit in the look-up table memory 313.

If the first address comparator 311a receives an (absolute) address (absAddr), the first address comparator 311a calculates the associated relative address (relAddr) in the look-up table memory 313 as follows:

$$\begin{matrix}RelAddr = {}^{⌊} ( absAddr - BOUND ( a ) ) / {GRAIN ( a )}^{⌋} + OFFSET ( a ) \\ = {}^{⌊} ( absAddr - BOUND ( a ) ) / {4}^{⌋} + OFFSET ( a ) .\end{matrix}$$

Since, in the exemplary embodiment according to FIG. 3, the parameter GRAIN(x) can also be respectively separately defined for the individual address comparators, that is to say can be assigned different values, further possibilities, in addition to the options already mentioned above (see description of FIG. 2), for making the address checking even more effective are presented:

For example, different granularities can be allocated to the individual address comparators, with the result that the different address ranges associated with the address comparators 311a-311n can be monitored with different resolution.

Although the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”. In addition, to the extent that the word “exemplary” is used herein, such term is meant to mean an example, rather than optimal or preferred.

What is claimed is:

1. An apparatus for formatting and preselecting trace data, the apparatus comprising:
a trace message generator;
an address checker comprising at least one look-up table; and
a memory operably coupled to the trace message generator and the address checker;
wherein the trace message generator is configured to receive an address and associated data and generate a trace message with the associated data for the received address;
wherein the address checker is configured to receive the address, check the received address with the aid of the look-up table, and generate an output signal that indicates whether or not the trace message generated for the address is intended to be stored;
wherein the memory is configured to receive the trace message generated by the trace message generator, receive the output signal generated by the address checker, and store the received message therein if the output signal indicates that the trace message is intended to be stored.

2. The apparatus as claimed in claim 1, wherein the apparatus and a processor, from which the address and the associated data are received, are arranged on a common chip.

3. The apparatus as claimed in claim 1, wherein the address checker comprises:
an investigation component configured to investigate whether the received address is in a predetermined address range,
wherein the output signal indicates that the trace message generated for the address is not intended to be stored when the received address is not in the predetermined address range.

4. The apparatus as claimed in claim 3, wherein the predetermined address range is configurable by a register.

5. The apparatus as claimed in claim 1, wherein the address checker comprises:
a plurality of address comparators each configured to determine whether the received address is in an address range respectively associated with the respective address comparator, generate a bit signal that is in a first state when the received address is in the associated address range and is in a second, different state when the received address is not in the associated address range, and generate a relative address based on the received address and parameters associated with the respective address comparator; and
a multiplexer configured to respectively receive the relative address and the bit signal from each of the address comparators and forward the relative address from each of the address comparators that output the respective bit signal that is in the first state;
wherein the address checker is further configured to check the received address using an entry in the look-up table, which entry is dictated by the relative address generated by the respective address comparator.

6. The apparatus as claimed in claim 1, wherein the look-up table is configured such that an entry in the look-up table is suitable for checking a plurality of different addresses.

7. The apparatus as claimed in claim 1, wherein an entry in the look-up table is suitable for checking a plurality of adjacent addresses, wherein a number of adjacent addresses that can be respectively checked by means of an entry in the look-up table.

8. The apparatus as claimed in claim 1, further comprising a clock generator configured to generate a time stamp, wherein the trace message generator is configured to insert the time stamp generated by the clock generator into the trace message.

9. The apparatus as claimed in claim 1, further comprising a high-speed interface configured to enable a read of the memory, and a transmission of the trace messages stored in the memory to an analysis apparatus.

10. An apparatus for formatting and preselecting trace data, comprising:
a trace data formatter;
an address tester comprising at least one look-up table; and
a memory connected to the trace data formatter and to the address tester;
wherein the trace data formatter is configured to receive an address and associated data and generate a trace message with the associated data for the received address;
wherein the address tester is configured to receive the address, check the received address with the aid of the at least one look-up table, and generate an output signal that indicates whether or not the trace message generated for the address is intended to be stored;
wherein the memory is configured to receive the trace message generated by the trace data formatter, receive the output signal generated by the address tester, and store the received trace message if the output signal indicates that the trace message is intended to be stored.

11. The apparatus as claimed in claim 10, wherein the apparatus and a processor, from which the address and the associated data are received, are arranged on a common chip.

12. The apparatus as claimed in claim 10, wherein an entry in the look-up table is suitable for checking a plurality of adjacent addresses, and a number of adjacent addresses that can be respectively checked by means of an entry in the look-up table is configurable.

13. The apparatus as claimed in claim 10, wherein the address tester comprises a plurality of address comparators that each receive the address and provide a bit signal indicating whether the address falls within a range of addresses associated therewith, wherein the range of addresses associated with each of the plurality of address comparators is unique.

14. The apparatus as claimed in claim 13, wherein each of the plurality of address comparators is configured to calculate a relative address, wherein if the received address falls within the range of addresses of the respective address comparator, the relative address indicates an associated position in the at least one look-up table.

15. The apparatus as claimed in claim 14, wherein the address tester further comprises a multiplexer configured to receive the bit signal from each of the plurality of address comparators, and pass the associated calculated relative address of any address comparator outputting a bit signal indicating that the received address falls within the respective range of addresses associated therewith.

16. The apparatus as claimed in claim 15, wherein the multiplexer is further configured to select a single calculated relative address from a plurality of calculated relative addresses in an instance when multiple address comparators provide the bit signal indicating the received address falls within the respective range of the address comparators, wherein the multiplexer is configured to select the single calculated relative address based on a priority associated with the address comparators.

17. The apparatus as claimed in claim 15, wherein the look-up table is configured to store a plurality of bits at various locations therein, wherein a value of the bits indicates whether or not the trace message generated for the received address is intended to be stored, and wherein the calculated relative address passed by the multiplexer points to a location of the corresponding bit in the look-up table.

18. The apparatus as claimed in claim 14, wherein each of the plurality of address comparators further comprises a register configured to store bound, range and offset parameters therein, wherein the bound and range parameters are employed in ascertaining the respective range of addresses associated with the respective address comparator, and the bound and offset parameters are employed in calculating the respective relative address.

19. The apparatus as claimed in claim 18, wherein each address comparator register further stores a grain parameter therein, wherein the grain parameter is employed to indicate a resolution of the respective address comparator.

20. A method for formatting and preselecting trace data, the method involving:
receiving an address and associated data;
generating a trace message with the associated data for the received address;
checking, with the aid of a look-up table, whether the trace message generated for the address is intended to be stored;
generating an output signal that indicates whether or not the trace message generated for the address is intended to be stored;
transmitting the generated trace message and the generated output signal to a memory apparatus; and
storing the generated trace message if the output signal indicates that the trace message is intended to be stored.
